(19) United States
(12) Patent Application Publication
(10) Pub. No.: US 2016/0158706 A1
(43) Pub. Date: Jun. 9, 2016

(54) MICRO-AND/OR NANO-SCALE PATTERNED POROUS MEMBRANES, METHODS OF MAKING MEMBRANES, AND METHODS OF USING MEMBRANES

(71) Applicant: KING ABDULLAH UNIVERSITY OF SCIENCE AND TECHNOLOGY, Thuwal (SA)

(72) Inventors: Xianbin WANG, Thuwal (SA); Wei CHEN, Thuwal (SA); Zhihong WANG, Thuwal (SA); Xixiang ZHANG, Thuwal (SA); Weisheng YUE, Thuwal (SA); Zhiping LAI, Thuwal (SA)

(21) Appl. No.: 14/905,291

(22) PCT Filed: Jul. 16, 2014
(86) PCT No.: PCT/IB2014/001596

§ 371 Date: Jan. 15, 2016

Related U.S. Application Data
(60) Provisional application No. 61/846,714, filed on Jul. 16, 2013.

(51) Int. Cl. B01D 67/00; B01D 71/02

(52) U.S. Cl. CPC B01D 67/0062; B01D 71/025; B01D 71/024; B01D 2325/028; B01D 2325/04; B01D 2325/08

(57) ABSTRACT

Embodiments of the present disclosure provide for materials that include a pre-designed patterned, porous membrane (e.g., micro- and/or nano-scale patterned), structures or devices that include a pre-designed patterned, porous membrane, methods of making pre-designed patterned, porous membranes, methods of separation, and the like.

### CROSS-REFERENCE TO RELATED APPLICATIONS

This application is the National Stage of International Application No. PCT/IB2014/001596, filed 16 Jul. 2014, which claims the benefit of and priority to U.S. Provisional Application No. 61/846,714, filed on 16 Jul. 2013, having the title “MICRO-AND/OR NANO-SCALE PATTERNED POROUS MEMBRANES, METHODS OF MAKING MEMBRANES, AND METHODS OF USING MEMBRANES”, the contents of all of which are incorporated by reference as if fully set forth herein.

### BACKGROUND

Membrane separation is a technique used in water desalination, petrochemical resource reuse, energy saving and environmental protection related industries, and life and medical science and engineering. Currently, many membranes use polymer materials, but these have drawbacks such as pore size control, high temperature operation, biological fouling, corrosion resistance, and the like. Thus, there is a need to overcome at least some of these deficiencies.

### SUMMARY

Embodiments of the present disclosure provide for materials that include a pre-designed, patterned, porous membrane (e.g., micro- and/or nano-scale patterned), structures or devices that include a pre-designed, patterned, porous membrane, methods of making pre-designed, patterned, porous membranes, methods of separation, methods of changing the size of openings in a membrane, and the like.

An embodiment of the present disclosure includes a structure, among others, that includes: a patterned, porous membrane having pre-designed patterned openings through the patterned, porous membrane, wherein one or more portions of the patterned, porous membrane are disposed on a substrate, wherein a portion of the openings are not blocked by the substrate, wherein the substrate is made of a first material selected from the group consisting of: silicon, metal, quartz, and ceramic, or the like, wherein the patterned, porous membrane is made of a second material selected from the group consisting of: SiO₂, Si₃N₄, Al₂O₂, ZrO₂, HfO₂, TiO₂, aluminum, iron, copper, titanium, polyimide, PMMA, PDMS, or the like, and a combination thereof, wherein the openings have a longest dimension across the opening of about 1 nm to 100 μm, and wherein the patterned porous membrane has a thickness of about 50 nm to 100 μm.

An embodiment of the present disclosure includes a separation device, among others, that includes a patterned, porous membrane of the present disclosure having pre-designed patterned openings.

An embodiment of the present disclosure includes a method of separating a substance, among others, that includes: exposing a substance to a structure, wherein the structure includes a patterned, porous membrane of the present disclosure having pre-designed patterned openings and separating a first component of the substance from a remainder of the components of the substance by them passing through the openings of the membrane when the first component passes through the membrane.

An embodiment of the present disclosure includes a method of making a pre-designed patterned membrane, among others, that includes: providing a thin layer of selected material as a blanket membrane disposed on a substrate; disposing a first resist on top of the blanket membrane; transferring a pre-designed patterned array with openings onto the first resist; etching the blanket membrane layer to form a plurality of openings in the blanket membrane layer thereby forming a patterned membrane layer, wherein the openings extend through the patterned membrane layer; and etching the substrate from the side opposite the patterned membrane layer to remove the substrate from an area to form a modified substrate, wherein a portion of the openings in the patterned membrane layer are not blocked by the modified substrate.

An embodiment of the present disclosure includes a method of changing the size of openings in a membrane, among others, that includes: adjusting the size of openings in a membrane by depositing a thin film on the membrane using a technique selected from the group consisting of atomic layer deposition (ALD), chemical vapor deposition (CVD), physical vapor deposition (PVD), and a combination thereof.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A and 1B illustrate two views of an embodiment of a patterned, porous membrane.

FIGS. 2A through 2H illustrate a representative embodiment of a method for fabricating a patterned, porous membrane as shown in FIGS. 1A and 1B.

FIG. 3A to 3C illustrate SEM images of an original zirconia hollow fiber membrane cross-section (A), a membrane surface (B), and a modified zirconia hollow fiber membrane made by 800 ALD cycles of Al₂O₃ coating (C).

FIG. 4A is a graph that illustrates the permeance of N₂ with ALD Al₂O₃ deposition cycles from 200 to 800. FIG. 4B is a graph that illustrates the permeance of N₂ with ALD Al₂O₃ deposition cycles of 600 and 800 with smaller scale.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Embodiments of the present disclosure will employ, unless otherwise indicated, techniques of material science, chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Discussion

Embodiments of the present disclosure provide for materials that include a pre-designed patterned, porous membrane (e.g., micro- and/or nano-scale), structures or devices that include a pre-designed patterned, porous membrane, methods of making pre-designed patterned, porous membranes, methods of separation, methods of changing the size of openings in a membrane, and the like.

In an embodiment, the patterned, porous membrane can be used in separation processes such as reverse osmosis, nano-filtration, ultra-filtration, micro-filtration, diffusion dialysis, and the like. In an embodiment, the patterned, porous membrane can be used to separate a component(s) from a substance such as a liquid, gas, solid, or a combination thereof. In an embodiment, the substance can be sea water, waste water, air, natural gas, a blood sample, and the like. Embodiments of the present disclosure can be used in desalination, waste water treatment, petrochemical and refinery industries, purification devices or systems, and the like.

In an exemplary embodiment, the patterned, porous membrane structure includes a pre-designed patterned, porous membrane layer that is disposed on one side of a substrate. In an embodiment, the patterned, porous membrane layer includes a plurality of pores (or openings) through the membrane layer, where the pores can be on the micro-scale, nano-scale, or a combination of pores having different micro-scale sizes and nano-scale sizes, (e.g., some on the micro-scale and some on the nano-scale). The terms “openings” and “pores” are used interchangeably in reference to the patterned, porous membrane layer.

In an embodiment, a portion of the pores is not blocked by the substrate, so one or more components of a substance to be separated from the substance can pass through the pores. For example the substrate can be positioned on the outside edges of the patterned, porous membrane layer so that all or substantially all of the pores are not blocked by the substrate, allowing components to pass into the pores of the membrane layer on a first side, pass through the inner surface of the membrane layer, and out of the pores on the other side of the membrane layer, while other components are not able to pass through the pores. In an embodiment, a support layer or structures (e.g., part of the substrate or another material) can support areas of the patterned porous membrane when the patterned porous membrane layer is large and/or needs additional support due to the conditions (e.g., pressure) of the separation process. In an embodiment, the area of the portion not blocked by the substrate can be about 100 μm² to 100 cm², or more.

In an embodiment, the substrate can be made of a material such as silicon, metal, quartz, ceramics, and the like. The dimensions of the substrate can vary depending upon the application, but in general, can be in the millimeter to tens of centimeters range.

In an embodiment, the patterned, porous membrane can be made of a material selected from: metal, metal oxides, SiO₂, Si₃N₄, Al₂O₂, ZrO₂, HfO₂, TiO₂, aluminum, iron, copper, titanium, polymers (e.g., polyimide, PMMA, PDMS, or similar polymers), or the like, and combinations thereof. In an embodiment, the pores can have a longest dimension (e.g., a diameter for a circular cross-section; length for an oblong cross-section) across the pores of about 1 nm to 10 millimeters, about 1 to 500 nm, about 1 to 250 nm, about 1 nm to 100 nm, about 500 nm to 1000 μm, about 1 to 100 μm, about 1 millimeter to about 10 millimeter, or any range within these ranges in increments of about 1 nm to 1 millimeter. The other dimensions (if not a circular cross section) such as length or width or the like can have dimensions similar to those noted above. In an embodiment, the longest dimension (e.g., diameter, length, width) of the nano-scale pores can be about 1 to 500 nm or about 1 to 250 nm, and the other dimension can be within this range. In an embodiment, the longest dimension of the micro-scale pores can be about 500 nm to 1000 pm or about 1 to 100 μm, and the other dimension can be within this range. In an embodiment, the patterned, porous membrane can have a thickness of about 50 nm to 100 μm. In an embodiment, the pores dimension through the patterned porous membrane can be about 50 nm to 100 μm or roughly the same thickness of the patterned, porous membrane.

In an embodiment, the patterned, porous membrane layer can be coated with one or more types of material on one or more areas of the patterned, porous membrane. In an embodiment, the coating can include materials such as Al₂O₃, TiO₂, ZnO, ZrO₂, TiO₂, and the like. In an embodiment, the coating can have a thickness in the range of about 1 nm to 10 μm, depending upon the dimensions of the patterned, porous membrane layer and the pores. In an embodiment, the coating can be formed before or after pore formation.

In an embodiment, the coating is not so thick as to block the pores (e.g., pores are large enough so the desired component can pass through the membrane). If, however, the coating is formed after formation of the pores, the coating can be used to narrow the dimensions of the pores, for instance, in order to adjust the size of pores according to the application.

As mentioned above, the plurality of pores can be the same size or can be a variety of sizes. In an embodiment, the pores can have the same shape or a variety of shapes or cross-sections (e.g., circular, oval, rectangular, polygonal, and the like). In an embodiment, the pores can be designed to have one or more patterns. In an embodiment, the density of the pores across the patterned, porous membrane can be the same or can have varying density across the patterned, porous membrane. In an embodiment, the size, shape, pattern, density, combinations of these, and the like, can vary depending upon the application.

In an embodiment, the size of the pores can be adjusted (e.g., widened or narrowed) using a technique such as atomic layer deposition, chemical vapor deposition, physical vapor deposition, and a combination thereof, where these techniques can be used to control growth and conformality around the pores. In an embodiment, membrane pore size adjustment can be carried out by atomic layer deposition (ALD) technique. By taking advantage of the atomic level growth control and the coating conformality of the ALD process, it is convenient to adjust the membrane pore size for separating a wide range of liquids and gases. In an embodiment, membranes other than those described herein can have their pore size or dimension(s) adjusted using techniques such as atomic layer deposition, chemical vapor deposition, physical vapor deposition, and a combination thereof.

In an embodiment, multiple distinct membrane structures can be overlaid (e.g., adjacent one another or having a space between each membrane structure) and can be used as part of a multi-part separation system. In an embodiment, the patterned, porous membrane layers may be separated from one another using one or more types of frame-shaped substrates as described herein or other spacing structures.

In an embodiment, one or more components of a substance can be separated from the remaining components of the substance (e.g., liquid, gas, solid, or combination thereof). In an embodiment, a substance is exposed to a structure or device including an embodiment of the patterned, porous membrane. Subsequently, one or more components of the substance can be separated from the remaining components of the substance using the patterned porous membrane. For example, one or more components pass through the membrane and other components do not pass through the membrane.

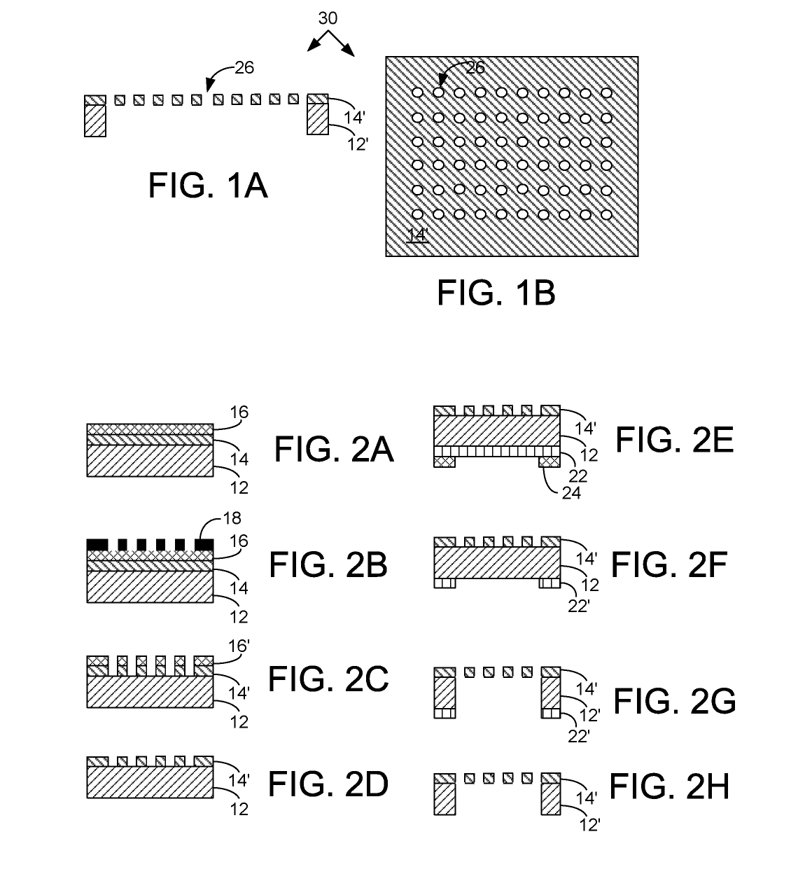

FIGS. 1A and 1B illustrate two views of an embodiment of a patterned porous membrane 30. FIG. 1A illustrates a cross-sectional view that shows the modified substrate 12′, the patterned porous membrane layer 14′, and the pores 26. FIG. 1B illustrates a top view that shows the patterned porous membrane layer 14′ and the pores 26.

For the purposes of illustration only, and without limitation, embodiments of the present disclosure will be described with particular reference to the below-described fabrication methods. Note that not every step in the process is described with reference to the process illustrated in the figures hereinafter. Therefore, the following fabrication processes are not intended to be an exhaustive list that includes every step required to fabricate the embodiments of the illustrated components. In addition, the steps of the process can be performed in a different order to accomplish the same result.

FIGS. 2A through 2H illustrate a representative embodiment of a method for fabricating a patterned, porous membrane 30 as shown in FIGS. 1A and 1B. FIG. 2A illustrates a first resist layer 16 disposed on a blanket membrane layer 14 that is disposed on a substrate 12. In an embodiment, the first resist layer 16 can be made of a material such as AZ 1505, AZ 1505HS, AZ 5214, ECI 3027, and the like. In an embodiment, the first resist layer 16 can have a thickness of about 200 nm to 10 μm. In an embodiment, the first resist layer 16 can be disposed on the blanket membrane layer 14 using techniques such as, but not limited to, spin coating, doctor-blading, screen or stencil-printing, and the like. In an embodiment, the blanket membrane layer 14 can be made of a material as described herein as it relates to the patterned, porous membrane layer 14′. In an embodiment, the blanket membrane layer 14 can have a thickness of about 50 nm to 100 μm. In an embodiment, the blanket membrane layer 14 can be disposed on the substrate 12 using techniques such as, but not limited to, spin coating, sputtering, atomic layer deposition, chemical vapor deposition (CVD), plasma enhanced CVD, and other plasma based deposition systems.

FIG. 2B illustrates the formation of a first photo- or etch-mask 18 on the first resist layer 16 (or positioned very close to, but not touching, the first resist layer 16.) In an embodiment, the first mask 18 can include a plurality of openings that can be used as a basis to ultimately form pores in the blanket membrane layer 14. In an embodiment, the pores can have a cross-sectional shape such as a circular, oval, rectangular, polygonal, and the like. In an embodiment, the longest distance across (e.g., diameter in a circle) a pore can be about 1 nm to 100 μm. In an embodiment, the first mask 18 can be made by a laser writing technique. In addition, there are other etch mask formation techniques that can be used in making the pre-patterned porous membrane available, such as electron beam lithography and X-ray lithography.

FIG. 2C illustrates the removal of a portion of the first resist layer 16 and the removal of a portion of the blanket membrane layer 14, where the portion corresponds to the openings of the first mask 18. Once the openings are formed in the layers, the layers are referred to as modified (or patterned) first resist layer 16′ and patterned membrane layer 14′. In an embodiment, the removal process can include techniques such as photoresist development, O₂ plasma descam, wet chemical etching, dry plasma etching, ion beam etching, and combinations thereof.

FIG. 2D illustrates the removal of the modified first resist layer 16′. In an embodiment, the removal process can include techniques such as wet chemical etching, dry plasma etching, and combinations thereof.

FIG. 2E illustrates the formation of the second resist layer 22 disposed on the substrate 12 on the side opposite the patterned porous membrane layer 14′. In addition, a second photo- or etch-mask 24 is positioned on or next to the second resist layer 22. In an embodiment, the second mask 24 can include openings that can be used as a basis to ultimately form an opening(s) in the substrate 12. In an embodiment, the opening can have a cross-sectional shape such as a circular, oval, rectangular, polygonal, and the like. In an embodiment, the longest distance across (e.g., diameter in a circle) the opening can be about micrometers to millimeters (e.g., 1 μm to 1000 millimeters). The second mask 24 and the second resist layer 22 can be similar or the same as the first mask 18 and the first resist layer 16.

FIG. 2F illustrates the removal of the second resist layer 22 to form a modified (or patterned) second resist layer 22′. In an embodiment, the removal process can include techniques such as photoresist development, O₂ plasma descam, wet chemical etching, dry plasma etching, and combinations thereof.

FIG. 2G illustrates the etching of the substrate 12 to form the modified substrate 12′. In an embodiment, the removal process can include techniques such as wet chemical etching, dry plasma etching, ion beam etching, and combinations thereof.

FIG. 2H illustrates the removal of the second resist layer 22′. In an embodiment, the removal process can include techniques such as wet chemical etching, dry plasma etching, and combinations thereof.

Although not shown in the figures, another step can include adjusting the size of the pores 26 using a technique such as atomic layer deposition, chemical vapor deposition, physical vapor deposition, and a combination thereof. Another step not shown can include disposing a material (e.g., a metal, titanium oxide, and the like) on the patterned porous membrane 14′ to provide desired characteristics.

### EXAMPLE

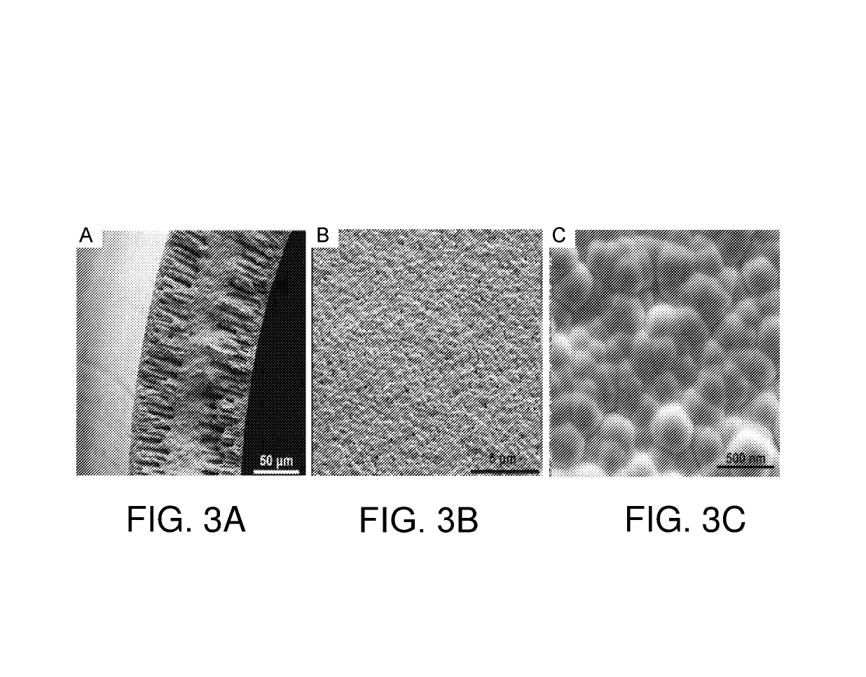

In an embodiment, membrane pore size adjustment was carried out by atomic layer deposition (ALD) technique. By taking advantage of the virtues of atomic level growth control and the coating conformality of the ALD process, it is convenient to adjust the membrane pore size for separating a wide range of liquids and gases. The experiment results provided demonstrate that membrane pore size adjustment is feasible (FIGS. 3A-3C), and therefore provides a technique to tailor the membrane for the application of separating different liquids and gases.

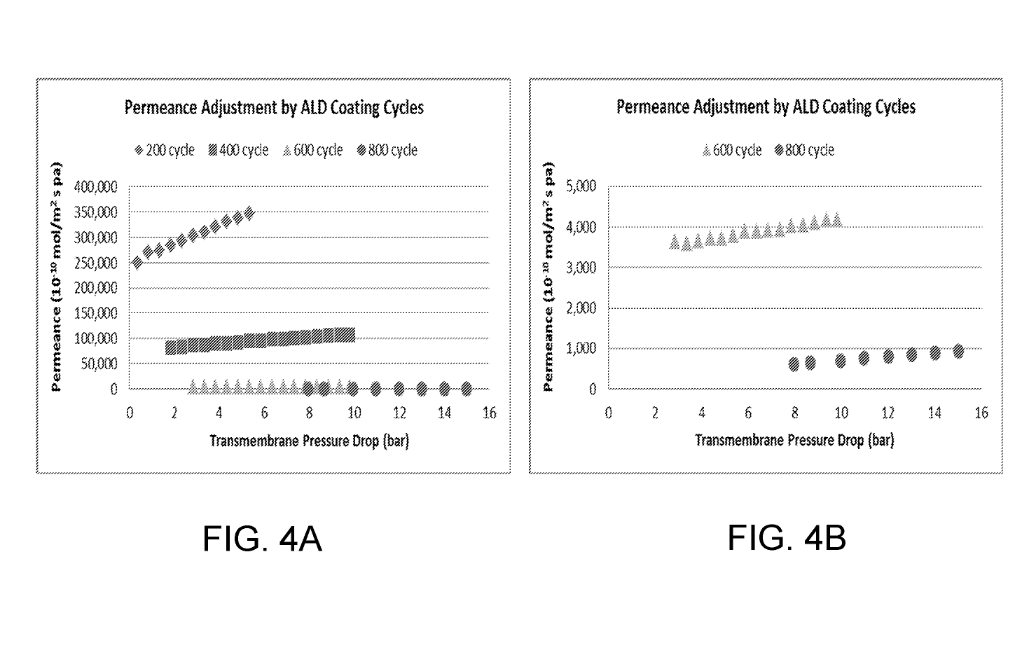

In order to effectively adjust the membrane pore size to meet a wide variety of application purposes, ALD deposition technique was employed to coat at least a portion of the surface of a membrane made of zirconia hollow fiber for membrane pore size adjustment. The Al₂O₃ coating was produced by varying ALD deposition cycle numbers of 200, 400, 600, and 800. Owing to the nature of atomic level growth control and the coating conformatility of the ALD technique provided, the Al₂O₃ thin film was formed layer by layer on the wall of the pore of the hollow fiber membrane; therefore, precision pore size control was realized. To demonstrate the concept, nitrogen gas under different pressure was applied on the zirconia hollow fiber coated with different ALD deposition cycles of Al₂O₃. The N₂ permeance reduction due to the pore size shrinkage was observed from the results shown in FIG. 4A and FIG. 4B.

FIGS. 3A-3C illustrate SEM images of original zirconia hollow fiber membrane cross-section (A), membrane surface (B), and modified zirconia hollow fiber membrane by formed by 800 ALD cycles of Al₂O₃ coating (C).

FIGS. 4A and 4B illustrate nitrogen gas permeance of the zirconia hollow fiber membrane with different ALD cycles of Al₂O₃ coating. FIG. 4A is a graph that illustrates the permeance of N₂ with ALD Al₂O₃ deposition cycles from 200 to 800. FIG. 4B is a graph that illustrates the permeance of N₂ with ALD Al₂O₃ deposition cycles of 600 and 800 with smaller scale. This demonstrates that the nitrogen gas permeance through the zirconia hollow fiber was tailored by ALD cycle number, indicating an effective and controllable adjustment of the membrane pore sizes.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the measuring technique and the numerical value. In addition, the phrase “about ‘x’ to ‘y’” includes “about ‘x’ to about ‘y’”.

While only a few embodiments of the present disclosure have been shown and described herein, it will become apparent to those skilled in the art that various modifications and changes can be made in the present disclosure without departing from the spirit and scope of the present disclosure. All such modification and changes coming within the scope of the appended claims are intended to be carried out thereby.

1. A structure, comprising:
a patterned, porous membrane having a plurality of pre-designed patterned pores through the patterned, porous membrane, wherein one or more portions of the patterned, porous membrane are disposed on a substrate, wherein a portion of the pores are not blocked by the substrate, wherein the substrate is made of a first material selected from the group consisting of: silicon, metal, quartz, and ceramic, wherein the patterned, porous membrane is made of a second material selected from the group consisting of: SiO₂, Si₃N₄, Al₂O₂, ZrO₂, HfO₂, TiO₂, aluminum, iron, copper, titanium, polyimide, PMMA, PDMS, and a combination thereof, wherein the pores have a longest dimension across the pore of about 1 nm to 100 μm, wherein the longest dimension can be a diameter, width, length, hypotenuse, or other dimension between two points of the pore opening that are at a greatest distance apart than any other two points along the pore opening, and wherein the patterned, porous membrane has a thickness of about 50 nm to 100 μm.

2. The structure of claim 1, wherein the pre-designed patterned pores of the membrane are selected from the group consisting of: micro-scale openings, nano-scale openings, or a combination thereof.

3. (canceled)

4. A method of separating a substance, the method comprising:
exposing a substance to a structure, wherein the structure includes a patterned porous membrane having pre-designed patterned pores through the patterned porous membrane, wherein one or more portions of the patterned porous membrane are disposed on a substrate, wherein a portion of the pores are not blocked by the substrate, wherein the substrate is made of a first material selected from the group consisting of: silicon, metal, quartz, and ceramic, wherein the patterned porous membrane is made of a second material selected from the group consisting of: SiO₂, Si₃N₄, Al₂O₂, ZrO₂, HfO₂, TiO₂, aluminum, iron, copper, titanium, polyimide, PMMA, PDMS, and a combination thereof, wherein the pores have a longest dimension across the opening of about 1 nm to 100 μm, and wherein the patterned porous membrane has a thickness of about 50 nm to 100 μm; and
separating a first component of the substance from a remainder of the components of the substance by them passing through the pores of the membrane when the first component passes through the membrane.

5. The method of claim 4, wherein the substance is selected from the group consisting of a gas, a liquid, a solid, and a combination thereof.

6. The method of claim 4, wherein the substance is selected from the group consisting of:
salt water, waste water, air, natural gas, and a blood sample.

7. A method of making a structure, comprising:
providing a thin layer of selected material as a blanket membrane disposed on a substrate;
disposing a first resist on top of the blanket membrane;
transferring a pre-designed patterned array with openings onto the first resist;
etching the blanket membrane layer to form a plurality of openings in the blanket membrane layer thereby forming a patterned membrane layer, wherein the openings extend through the patterned membrane layer; and
etching the substrate from the side opposite the patterned membrane layer to remove the substrate from an area to form a modified substrate, wherein a portion of the openings in the patterned membrane layer are not blocked by the modified substrate.

8. The method of claim 7, further comprising:
adjusting the size of the openings in the patterned membrane layer by depositing a thin film on at least a portion of the patterned membrane using a technique selected from the group consisting of atomic layer deposition (ALD), chemical vapor deposition (CVD), physical vapor deposition (PVD), and a combination thereof.

9. The method of claim 7, wherein the substrate is made of a first material selected from the group consisting of: silicon, metal, quartz, ceramics, and a combination thereof.

10. The method of claim 7, wherein the membrane is made of a material selected from the group consisting of: SiO₂, Si₃N₄, Al₂O₂, ZrO₂, HfO₂, TiO₂, aluminum, iron, copper, titanium, polyimide, PMMA, PDMS, and a combination thereof.

11. The method of claim 7, wherein the openings have a longest dimension across the opening of about 1 nm to 100 μm.

12. The method of claim 7, wherein the pre-designed patterned openings of the membrane are selected from the group consisting of: micro-scale openings, nano-scale openings, or a combination thereof.

13. The method of claim 7, wherein the patterned, porous membrane has a thickness of about 50 nm to 100 μm.

14. The method of claim 7, wherein the openings are not all the same size.

15. The method of claim 7, wherein the openings form one or more patterns in the membrane.

16. The method of claim 7, further comprising: disposing a coating on a portion of the modified substrate.

17. The method of claim 7, wherein the thin film deposited on the membrane is made of a material selected from the group consisting of: SiO₂, Si₃N₄, Al₂O₂, ZrO₂, HfO₂, TiO₂, aluminum, iron, copper, titanium, polyimide, PMMA, PDMS, and a combination thereof.

18. (canceled)
